(19) United States
(12) Patent Application Publication
(10) Pub. No.: US 2017/0061682 A1
(43) Pub. Date: Mar. 2, 2017

(54) RENDERING METHOD AND APPARATUS

(71) Applicant: Samsung Electronics Co., Ltd., Suwon-si (KR)

(72) Inventors: Minkyu JEONG, Yongin-si (KR); Jeongsoo PARK, Gwacheon-si (KR); Minyoung SON, Hwaseong-si (KR); Kwontaek KWON, Hwaseong-si (KR); Sangoak Woo, Anyang-si (KR); Donghoon YOO, Suwon-si (KR)

(73) Assignee: Samsung Electronics Co., Ltd., Suwon-si (KR)

(21) Appl. No.: 15/131,835

(22) Filed: Apr. 18, 2016

(30) Foreign Application Priority Data
Aug. 27, 2015 (KR) 10-2015-0121034

(51) Int. Cl. G06T 15/80; G06T 17/20; G06T 15/00; G06T 15/04

(52) U.S. Cl. CPC G06T 15/80; G06T 15/04; G06T 17/20; G06T 15/005

(57) ABSTRACT

A rendering method includes: obtaining primitives; obtaining a fragment shading order that is an order of shading fragments included in the obtained primitives; determining a rasterization order corresponding to the obtained fragment shading order; and performing rasterization on the fragments according to the determined rasterization order.

### CROSS-REFERENCE TO RELATED APPLICATION(S)

This application claims the benefit under 35 USC 119(a) of Korean Patent Application No. 10-2015-0121034, filed on Aug. 27, 2015, in the Korean Intellectual Property Office, the entire disclosure of which is incorporated herein by reference for all purposes.

### BACKGROUND

1. Field

The following description relates to rendering methods and apparatuses.

2. Description of Related Art

The terminology ‘3-dimensional (3D) graphics’ refers to a technique for displaying an object on a display in a solid state instead of a plane state and is mostly used to display a solid image used in movies including special effects, geographical analysis, and architectural or automobile design using computer aided design (CAD). Recently, 3D graphics has become widely used in games.

In order to produce a 3D image having a cubic effect, a 3D graphics system divides objects formed of many dots into polygons (e.g., a triangle, etc.) and performs rendering after interpolating pixels included in each polygon through rasterization. The 3D graphics system performs rasterization on pixels within a triangle.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to one general aspect, a rendering method includes: obtaining primitives; obtaining a fragment shading order that is an order of shading fragments included in the obtained primitives; determining a rasterization order corresponding to the obtained fragment shading order; and performing rasterization on the fragments according to the determined rasterization order.

The fragment shading order may include an order of accessing data stored in a memory in order to perform fragment shading.

The determining of the rasterization order may include determining at least one rasterization order from among previously set rasterization orders.

The previously set rasterization orders may include at least one selected from a Z order, an N order, and a U order.

The determining of the rasterization order may include: obtaining an orientation of a texture corresponding to the primitives; and determining the rasterization order based on the obtained orientation of the texture.

The obtaining of the orientation of the texture corresponding to the primitives may include obtaining the orientation of the texture by determining whether the texture corresponding to the primitives has a horizontal orientation or a vertical orientation.

The obtaining of the orientation of the texture corresponding to the primitives may include obtaining the orientation of the texture by using a value of coordinates of vertices forming the primitives.

The obtaining of the orientation of the texture corresponding to the primitives may include obtaining the orientation of the texture by using a difference between a value of coordinates of a leftmost vertex of the primitives and a value of coordinates of a rightmost vertex of the primitives.

The determining of the rasterization order corresponding to the obtained fragment shading order may include determining the rasterization order according to an order of accessing texture data stored in a memory to obtain values of pixels or values of fragments.

According to another general aspect, a non-transitory computer-readable recording medium includes stored instructions that are executable to cause a computer to perform the method.

According to another general aspect, a rendering device includes: a processor including an order determiner configured to obtain primitives and a fragment shading order that is an order of shading fragments included in the obtained primitives, and to determine a rasterization order corresponding to the obtained fragment shading order, and a rasterizer configured to perform rasterization on the fragments according to the determined rasterization order.

The fragment shading order may include an order of accessing data stored in a memory in order to perform fragment shading.

The order determiner may be further configured to determine at least one rasterization order from among previously set rasterization orders.

The previously set rasterization orders may include at least one of a Z order, an N order, and a U order.

The order determiner may be further configured to: obtain an orientation of a texture corresponding to the primitives; and determine the rasterization order based on the obtained orientation of the texture.

The order determiner may be further configured to obtain the orientation of the texture corresponding to the primitives by determining whether the texture has a horizontal orientation or a vertical orientation.

The order determiner may be further configured to obtain the orientation of the texture corresponding to the primitives by using values of coordinates of vertices forming the primitives.

The order determiner may be further configured to obtain the orientation of the texture corresponding to the primitives by using a difference between a value of coordinates of a leftmost vertex of the primitives and a value of coordinates of a rightmost vertex of the primitives.

The order determiner may be further configured to determine the rasterization order according to an order of accessing texture data stored in a memory to obtain values of pixels and values of fragments.

According to another general aspect, a rendering method includes: obtaining primitives; and determining a rasterization order based on an orientation of a texture corresponding to the primitives.

The rasterization order may correspond to a fragment shading order that is an order of shading fragments included in the obtained primitives.

The determining of the rasterization order may include determining at least one rasterization order from among previously set rasterization orders.

The rendering method may further include obtaining the orientation of the texture corresponding the primitives by determining whether the texture has a horizontal orientation or a vertical orientation.

Other features and aspects will be apparent from the following detailed description, the drawings, and the claims.

### BRIEF DESCRIPTION OF THE DRAWINGS

FIG. 1 is a diagram of a graphic processing device according to an embodiment.

FIG. 2 is a diagram of a method of processing, by a graphic processing device, three-dimensional (3D) graphics, according to an embodiment.

FIG. 3 is a diagram of a structure and operations of a rendering device, according to an embodiment.

FIG. 4 is a flowchart of a method of performing, by the rendering device, rasterization according to a fragment shading order, according to an embodiment.

FIG. 5 is a flowchart of a method of performing, by the rendering device, rasterization according to an order of accessing data stored in a memory, according to an embodiment.

FIG. 6 is a flowchart of a method of performing, by the rendering device, rasterization based on an orientation of a texture, according to an embodiment.

FIG. 7A is a diagram of an order of performing, by the rendering device, rasterization, according to an embodiment.

FIG. 7B is a diagram of a memory accessed by the rendering device to perform rendering, according to an embodiment.

FIG. 8A is a diagram of a method of performing, by the rendering device, rasterization when an orientation of a texture is changed, according to an embodiment.

FIG. 8B is a diagram of a method of performing, by the rendering device, rasterization in an N order when an orientation of a texture is changed, according to an embodiment.

FIG. 9 is a diagram of a method of determining, by the rendering device, an orientation of a texture, according to an embodiment.

FIG. 10A is a diagram of a method of performing, by the rendering device, rasterization in a rightward direction, according to an embodiment.

FIG. 10B is a diagram of a method of performing, by the rendering device, rasterization in a downward direction, according to an embodiment.

FIG. 10C is a diagram of a method of performing, by the rendering device, rasterization in a Z order, according to an embodiment.

FIG. 10D is a diagram of a method of performing, by the rendering device, rasterization in an N order, according to an embodiment.

FIG. 10E is a diagram of a method of performing, by the rendering device, rasterization in a U order, according to an embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

While such terms as “first”, “second”, etc., may be used to describe various components, such components must not be limited to the above terms. The above terms are used only to distinguish one component from another.

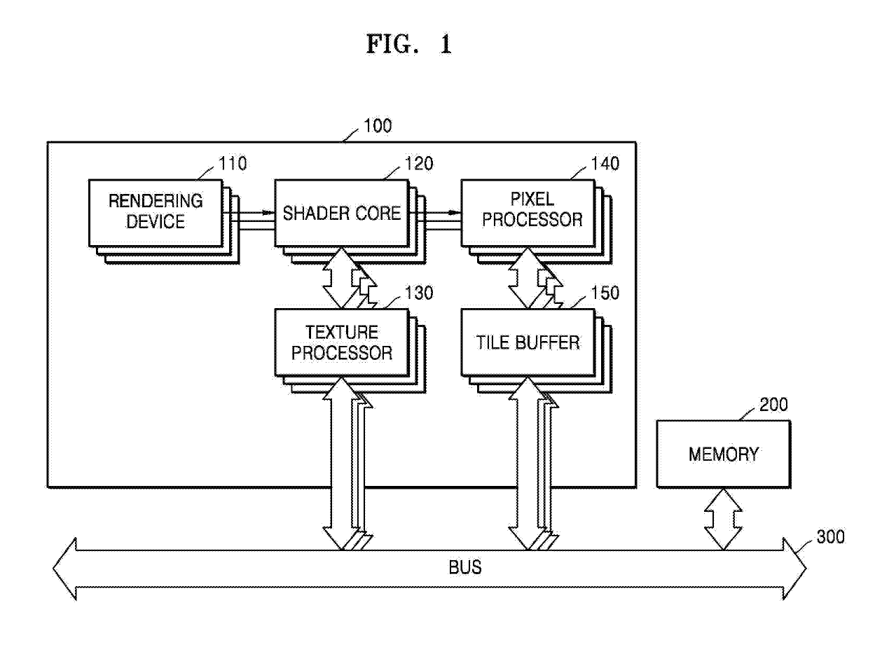

FIG. 1 is a diagram of a graphic processing device 100 according to an embodiment. One of ordinary skill in the art will understand that other components may be further included in the graphic processing device 100 in addition to the components illustrated in FIG. 1.

Referring to FIG. 1, the graphic processing device 100 includes a rendering device 110, a shader core 120, a texture processor 130, a pixel processor 140, a tile buffer 150, and the like. The graphic processing device 100 receives/transmits data from/to an external memory 200 via a bus 300.

The graphic processing device 100 of FIG. 1 is a device for processing 3D graphics and uses a tile based rendering (TBR) method. In other words, the graphic processing device 100 allows tiles, which are divided to have a certain size, to undergo processing by the rendering device 110, the shader core 120, and the pixel processor 140 in order to generate 3D graphics corresponding to one frame, and stores a processing result in the tile buffer 150. The graphic processing device 100 may process all tiles forming a frame in parallel by using channels formed by the rendering device 110, the shader core 120, and the pixel processor 140. When the tiles corresponding to the frame are processed, the graphic processing device 100 transmits the processing result stored in the tile buffer 150 to a frame buffer (not shown) of the memory 200.

The rendering device 110 performs rasterization on primitives generated by a vertex shader through geometric transformation.

The shader core 120 performs pixel shading after receiving, from the rendering device 110, the primitives on which the rasterization is performed. The shader core 120 performs the pixel shading on all pixels including fragments of the primitives generated through the rasterization, and the pixel shading is performed to determine colors of all pixels forming a tile. The shader core 120 uses pixel values generated by using textures in order to generate 3D graphics, which are solid and have a sense of reality, while the pixel shading is performed.

The shader core 120 may include a pixel shader. Also, the shader core 120 may further include a vertex shader. Alternatively, the shader core 120 may be a shader in which a vertex shader and a pixel shader are combined. When the shader core 120 is able to perform a function of the vertex shader, the shader core 120 generates a primitive indicating an object and transmits the generated primitive to the rendering device 110.

When the shader core 120 requests the texture processor 130 to transmit pixel values corresponding to desired pixels, the texture processor 130 transmits pixels values that are generated by processing a texture that is prepared in advance to the shader core 120. The texture is stored in a certain space inside or outside the texture processor 130, or in the memory 200 outside the graphic processing device 100. When the texture, which is used to generate the pixel values required by the shader core 120, does not exist in the certain space inside the texture processor 130, the texture processor 130 obtains a texture from the space outside the texture processor 130 or the memory 200 and uses the same.

The pixel processor 140 determines a pixel value, which is to be finally displayed, by conducting a depth test, etc., for all pixels located at the same location within a tile, and determines all pixel values corresponding to the tile.

The tile buffer 150 stores all of the pixel values corresponding to the tile transmitted by the pixel processor 140. When a graphic processing process for all pixels forming one frame is completed, the processing result stored in the tile buffer 150 is transmitted to a frame buffer of the memory 200.

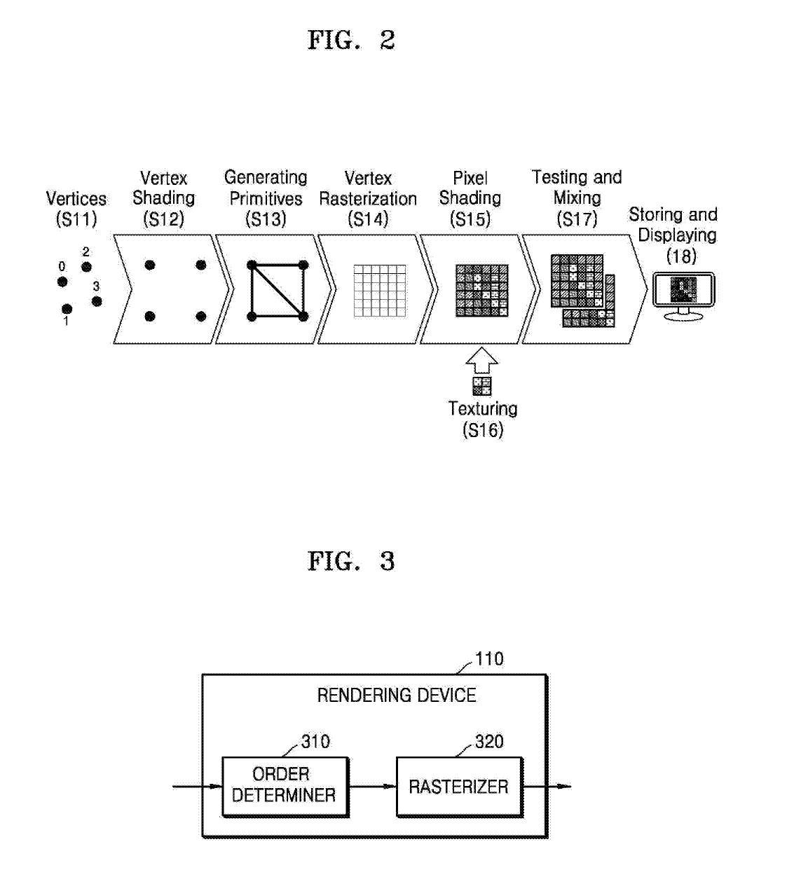

FIG. 2 is a diagram of a method of processing 3D graphics by the graphic processing device 100. The method of processing the 3D graphics is divided into 3 processes: geometric transformation, rasterization, and pixel shading. The details of these processes will be described below with reference to FIG. 2.

Referring to FIG. 2, the process of processing the 3D graphics includes operations S11 to S18.

In operation S11, vertices are generated to indicate objects included in 3D graphics.

In operation S12, the generated vertices are shaded. The vertex shader performs shading on the generated vertices by designating locations of the generated vertices.

In operation S13, primitives are generated. A primitive denotes a dot, a line, a polygon, or the like that is formed by using at least one vertex. For example, a primitive may be a triangle formed by connecting the vertices.

In operation S14, the primitives are rasterized. The rasterization of the primitives means that the primitives are divided into fragments. The fragment is a basic unit for performing graphic processing on the primitives. Since the primitive only includes information about the vertices, the graphic processing for the 3D graphics is performed by generating the vertices and the fragments between the vertices during the rasterization.

In operation S15, pixels are shaded. The fragments of the primitives generated through the rasterization become pixels forming a tile. The use of terms “fragment” and “pixel” may be interchanged according to cases. For example, a pixel shader may be referred to as a fragment shader. In general, a basic unit of graphic processing forming primitives may be referred to as a fragment, and a basic unit of graphic processing starting from the pixel shading may be referred to as a pixel. During the pixel shading, colors of pixels may be determined.

In operation S16, texturing is performed to determine colors of pixels. The texturing is a process of determining the colors of pixels by using a texture that is a previously-prepared image. Calculating and determining colors of respective pixels to display real-world colors and patterns increases a data calculating amount and a graphic processing time which are necessary for the graphic processing, and thus, the colors of the pixels are determined by using the previously-prepared texture. For example, the colors of pixels may be determined by combining texels. The texels are combined by storing a surface color of an object as a 2D image, that is, a texture, enlarging or reducing a texture, which is stored according to a location of the object on a display, a size thereof, etc., or by using textures having different resolutions.

In more detail, values of pixels generated by using the previously-prepared texture are used to process the 3D graphics more quickly during the pixel shading. In this case, textures having different resolutions are prepared in advance in order to adaptively correspond to the size of the object, and the values of the pixels are generated by combining the textures. In this case, the textures that have different resolutions and are prepared in advance are referred to as mipmaps. For example, in order to generate values of pixels of an object having an intermediate resolution between two mipmaps that are prepared in advance, values of texels, which are at a location corresponding to the object, are extracted from the mipmaps and filtered to generate values of the pixels forming the object.

In operation S17, testing and mixing are performed. A pixel value, which is to be finally displayed, is determined by conducting a depth test, etc., for all pixels located at the same location within a tile. Then, all pixel values corresponding to one tile are determined. Therefore, 3D graphics corresponding to a frame are generated by mixing tiles generated through the above process.

In operation S18, the frame generated through operations S11 to S17 is stored in the frame buffer, and the stored frame is displayed through a display device.

FIG. 3 is a diagram of a structure and operations of the rendering device 110, according to an embodiment.

Referring to FIG. 3, the rendering device 110 includes an order determiner 310 and a rasterizer 320. The rendering device 110 as shown in FIG. 3 only includes components related to the example embodiment. Therefore, one of ordinary skill in the art will understand that other general-use components may be further included in the rendering device 110 in addition to the components illustrated in FIG. 3.

Additionally, one of ordinary skill in the art will understand that the order determiner 310 and the rasterizer 320 may be independent devices. Also, the order determiner 310 and the rasterizer 320 may be one or more processors. The processor(s) may be implemented as an array of logic gates or as a combination of a general-purpose microprocessor and a memory storing a program executable by the microprocessor. In addition, one of ordinary skill in the art would understand that the processor may be implemented as hardware.

The order determiner 310 obtains primitives. The primitive may be dots, lines, or polygons formed by using at least one vertex. For example, the primitives may be triangles formed by connecting vertices.

For example, the order determiner 310 may obtain primitives from a primitive generator (not shown). The primitive generator may generate primitives by receiving vertices determined through Viewport mapping.

The order determiner 310 obtains a fragment shading order that is a shading order regarding fragments included in the obtained primitives. The fragment according to an embodiment is a basic unit of graphic processing forming the primitives, and the use of the terms ‘fragment’ and ‘pixel’ may be interchanged.

The fragment shading is performed by the shader core 120. The shader core 120 performs the fragment shading, for example, by obtaining values of fragments included in the primitives or pixels.

For example, the shader core 120 may apply one or more effects to respective fragments generated by executing codes produced by a shader programmer. For example, the shader core 120 may calculate colors of the fragments by calculating texture mapping, light reflection, etc., or may remove a certain fragment based on a discard command.

The order determiner 310 obtains the fragment shading order that is the shading order regarding fragments.

For example, the order determiner 310 obtains information regarding an order of accessing data stored in a memory in order to perform the fragment shading. For example, the order determiner 310 determines a rasterization order according to an order of accessing texture data stored in a memory in order to obtain pixel values or fragment values. For example, the order determiner 310 obtains an order regarding a memory address used to access dynamic random access memory (DRAM) during rendering. The fragment shading order may include the order of accessing the data stored in the memory in order to perform the fragment shading.

As another example, the order determiner 310 obtains an orientation of a texture corresponding to the primitives on which the rendering is performed and determines the rasterization order based on the obtained orientation of the texture. The fragment shading order is a fragment shading order according to the orientation of the texture.

More specifically, the fragment shading order is determined based on the orientation of the texture. For example, a case where the DRAM storing the data in a stated order of first data and second data is accessed will be described. When a direction of a texture is a first direction, the graphic processing device 100 may process a left fragment based on the first data and a right fragment based on the second data. When a direction of a texture is a second direction, the graphic processing device 100 may process the left fragment based on the second data and the right fragment based on the first data. In this case, when the direction of the texture is the first direction, the fragment shading order may be in a rightward direction, and when the direction of the texture is the second direction, the fragment shading order may be in a leftward direction. The order determiner 310 determines the rasterization order according to the fragment shading order determined based on the orientation of the texture.

The order determiner 310 obtains the orientation of the texture by determining whether the texture corresponding to the primitives has a horizontal or vertical orientation and may determine the rasterization order based on the obtained orientation of the texture. For example, when the texture has the horizontal orientation, the rasterization order is determined as a Z order. When the texture has the vertical orientation, the rasterization order is determined as an N order. As another example, when the texture has the horizontal orientation, the rasterization order may be determined to be in a rightward direction, and when the texture has the vertical orientation, the rasterization order may be determined to be in a downward direction.

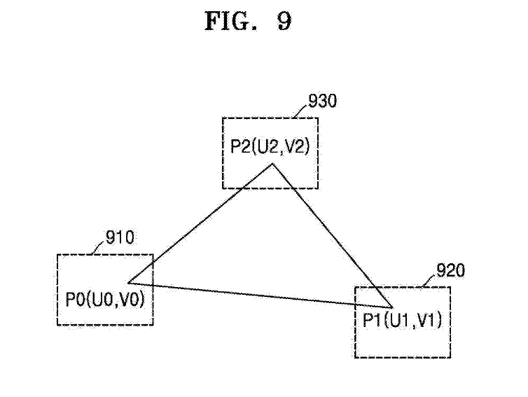

The order determiner 310 obtains the orientation of the texture by using coordinate values of vertices forming the primitives. For example, the order determiner 310 obtains the orientation by using a difference between coordinates of a leftmost vertex of the primitives and coordinates of a rightmost vertex of the primitives. For example, the order determiner 310 selects a leftmost vertex and a rightmost vertex to obtain an x-axis coordinate difference ΔU and a y-axis coordinate difference ΔV between vertices and compares a size of the x-axis coordinate difference ΔU with a size of the y-axis coordinate difference ΔV. When the x-axis coordinate difference ΔU is greater than the y-axis coordinate difference ΔV, the texture is determined to have the horizontal orientation, and when the y-axis coordinate difference ΔV is greater than the x-axis coordinate difference ΔU, the texture is determined to have the vertical orientation. The above example embodiment of a method of determining the orientation of a texture will be described in further detail later with reference to FIG. 9.

The order determiner 310 determines the rasterization order to correspond to the obtained fragment shading order. As used herein, the term “rasterization” refers to an arbitrary technique of transforming color values or vectors into a raster form. In detail, the rasterization of primitives means that the primitives are divided into fragments. For example, the rendering device 110 may generate fragments in a vertex by interpolating screen coordinates, texture coordinates, etc. defined at each vertex in the primitives. The fragment is a basic unit used to perform graphic processing on the primitives. Since the primitive only includes information regarding the vertex, vertices and fragments between the vertices are generated during the rasterization, and thus, the graphic processing may be performed on 3D graphics.

For example, when the fragment shading order obtained by the order determiner 310 is in a rightward direction of the primitives, the order determiner 310 determines the rasterization order in the rightward direction.

As another example, when a direction corresponding to the fragment shading order obtained by the order determiner 310 is in a Z order, the Z order is determined as the rasterization order. The Z order may be an order from an upper left portion of the primitive to an upper right portion, then to a lower left portion of the primitive, and then to a lower right portion of the primitive.

As another example, when the direction corresponding to the fragment shading order obtained by the order determiner 310 is an N order, the N order is determined as the rasterization order. The N order may be an order from a lower left portion of the primitive to an upper left portion of the primitive, then to a lower right portion of the primitive and then to an upper right portion.

As another example, when the direction corresponding to the fragment shading order obtained by the order determiner 310 is a U order, the U is determined as the rasterization order. The U order may be an order from an upper left portion to a lower left portion of the primitive, then to a lower right portion of the primitive and then to an upper right portion of the primitive.

Thus, as described above, the order determiner 310 determines the rasterization order corresponding to the fragment shading order from among at least one of the rightward-direction order, the downward-direction order, the Z order, the N order, and the U order. For example, when a fragment shading order corresponding to the order of accessing the data stored in the memory is the Z order from among the rightward-direction order, the downward-direction order, the Z order, the N order, and the U order, the order determiner 310 determines the Z order as the rasterization order.

The rasterizer 320 performs rasterization on fragments according to the rasterization order determined by the order determiner 310. For example, when the rasterization order determined by the order determiner 310 is in the rightward direction, the rasterizer 320 may perform the rasterization in the rightward direction. For example, the rasterizer 320 may divide a primitive into one or more fragments in the rightward direction. As another example, the rasterizer 320 may generate fragments in a vertex by interpolating screen coordinates, texture coordinates, etc. defined at each vertex in the primitives in the rightward direction. As another example, the rasterizer 320 may obtain pixels or fragments included in the primitives in the rightward direction.

As another example, when the rasterization order determined by the order determiner 310 is in a Z direction, the rasterizer 320 performs the rasterization in the Z direction. As another example, when the rasterization order determined by the order determiner 310 is in an N direction, the rasterizer 320 performs the rasterization in the N direction. As another example, when the rasterization order determined by the order determiner 310 is in a U direction, the rasterizer 320 performs the rasterization in the U direction.

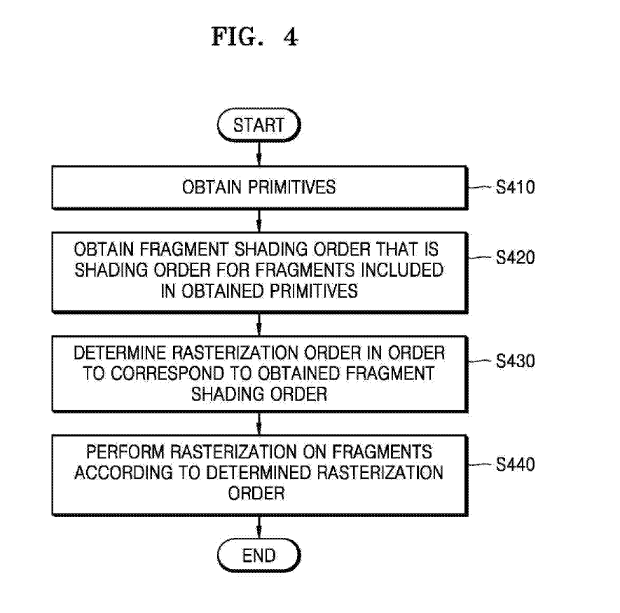

FIG. 4 is a flowchart of a method of performing, by the rendering device 110, rasterization according to a fragment shading order, according to an embodiment.

In operation S410, the rendering device 110 obtains primitives. The primitives may be received from an outside of the rendering device 110. For example, a primitive generated by a primitive generation unit (not shown) may be received by the rendering device 110. The primitive generation unit according to an embodiment may generate primitives by receiving vertices that are determined through viewpoint mapping.

In operation S420, the rendering device 110 obtains a fragment shading order that is an order of shading fragments included in the primitives obtained in operation S410. The fragments according to an embodiment are basic units of graphic processing forming primitives, and the use of the terms ‘fragment’ and ‘pixel’ may be interchanged.

For example, the rendering device 110 obtains information about an order of accessing data stored in a memory in order to perform fragment shading. For example, the rendering device 110 determines a rasterization order according to an order of accessing texture data stored in the memory in order to obtain pixel values or fragment values. For example, the rendering device 110 obtains an order for a memory address used to access DRAM while rendering is performed. The fragment shading order includes the order of accessing the data stored in the memory in order to perform the fragment shading.

As another example, the rendering device 110 obtains an orientation of a texture corresponding to the primitives on which rendering is performed and may determine a rasterization order based on the obtained orientation. The fragment shading order is a fragment shading order according to the orientation of the texture.

The fragment shading order is determined based on the orientation of the texture. For example, a case where the DRAM storing data is accessed in an order from first data to second data will be described. When an orientation of a texture is a first direction, the graphic processing device 100 may process a left fragment based on the first data and a right fragment based on the second data. When an orientation of a texture is a second direction, the graphic processing device 100 may process the left fragment based on the second data and the right fragment based on the first data. In this case, when the orientation of the texture is the first direction, the fragment shading order is a rightward direction, and when the orientation of the texture is the second direction, the fragment shading order is a leftward direction. The rendering device 110 determines the rasterization order according to the fragment shading order determined based on the orientation of the texture.

In operation S430, the rendering device 110 determines the rasterization order to correspond to the fragment shading order obtained in operation S420. For example, when the fragment shading order obtained by the rendering device 110 is in a rightward direction, the rendering device 110 determines the rasterization order in the rightward direction.

As another example, when a direction corresponding to the fragment shading order obtained by the rendering device 110 is in a Z order, the Z order is determined as the rasterization order. The Z order may be an order from an upper left portion of the primitive, to an upper right portion of the primitive, then to a lower left portion of the primitive, and then to a lower right portion of the primitive.

As another example, when the direction corresponding to the fragment shading order obtained by the rendering device 110 is in an N order, the N order may be determined as the rasterization order. The N order may be an order from a lower left portion of the primitive to an upper left portion of the primitive, then to a lower right portion of the primitive and then to an upper right portion of the primitive.

As another example, when the direction corresponding to the fragment shading order obtained by the rendering device 110 is in a U order, the U order may be determined as the rasterization order. The U order may be an order from an upper left portion of the primitive to a lower left portion of the primitive, then to a lower right portion of the primitive and then to an upper right portion of the primitive.

The rendering device 110 determines one of the predetermined rasterization orders in order to correspond to the obtained fragment shading order.

Thus, as described above, the rendering device 110 determines the rasterization order corresponding to the fragment shading order from among at least one of the rightward-direction order, the downward-direction order, the Z order, the N order, and the U order. For example, when a fragment shading order corresponding to the order of accessing the data stored in the memory is the Z order from among the rightward-direction order, the downward-direction order, the Z order, the N order, and the U order, the rendering device 110 determines the Z order as the rasterization order.

In operation S440, the rendering device 110 performs rasterization on the fragments according to the rasterization order determined in operation S430. For example, when the rasterization order determined by the rendering device 110 is in the rightward direction, the rendering device 110 performs the rasterization in the rightward direction. For example, the rendering device 110 may divide the primitive into one or more fragments in the rightward direction. As another example, the rendering device 110 may generate fragments within the vertex by interpolating the screen coordinates, texture coordinates, etc. defined at each vertex of the primitive in the rightward direction. As another example, the rendering device 110 may obtain pixels or fragments included in the primitives in the rightward direction.

As another example, when the rasterization order determined by the rendering device 110 is a Z direction, the rendering device 100 performs rasterization in the Z direction. As another example, when the rasterization order determined by the rendering device 110 is an N direction, the rendering device 100 performs rasterization in the N direction. As another example, when the rasterization order determined by the rendering device 110 is a U direction, the rendering device 100 performs rasterization in the U direction.

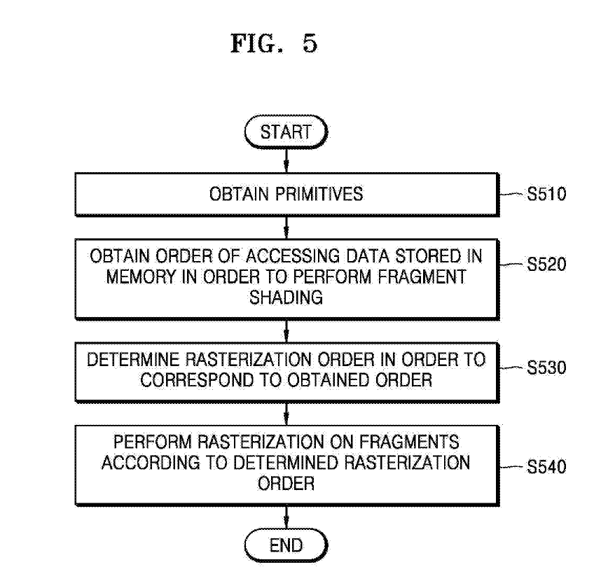

FIG. 5 is a flowchart of a method of performing, by the rendering device 110, rasterization according to an order of accessing data stored in a memory, according to an embodiment.

Operations S510 and S540 respectively correspond to operations S410 and S440, and thus, details thereof are omitted.

In operation S520, the rendering device 110 obtains an order of accessing data stored in a memory in order to perform fragment shading. The rendering device 110 accesses the data stored in the memory in order to perform the fragment shading. For example, the rendering device 110 may perform the rendering by receiving data stored in cache memory.

When the rendering device 110 accesses the data stored in the memory in order to perform the fragment shading, an order of accessing the memory is determined. For example, the order of accessing the memory may be determined in a way for increasing a cache hit ratio. For example, the order of accessing the memory may be determined in a way in which the data currently stored in the cache memory is used first. When the data currently stored in the cache memory includes data regarding first and second pixels, and data that is not currently stored in the cache memory includes data regarding third and fourth pixels, an order of accessing an address of the cache memory storing the data regarding the first pixel and an address of the cache memory storing the data regarding the second pixel may be prior to an order of accessing an address of the cache memory storing the data regarding the third pixel and an address of the cache memory storing the data regarding the fourth pixel.

The graphic processing device 100 determines the order of accessing the data in a manner in which a priority is provided to data stored in cache memory or DRAM and performs fragment shading according to the determined order. In this case, the rendering device 110 obtains the determined order of accessing the data.

The graphic processing device 100 determines the order of accessing the data in a manner in which a priority is provided to data that may be easily accessed from among pieces of data stored in the cache memory or DRAM and may perform fragment shading according to the determined order. For example, a higher priority may be assigned to a piece of data stored in a fore address space of the DRAM than to a piece of data stored in a rear address space. In this case, the determined order of accessing the data may be obtained by the rendering device 110.

In operation S530, the rendering device 110 determines a rasterization order in order to correspond to the order of accessing data obtained in operation S520. For example, when an order of accessing the data regarding the first pixel is ahead of an order of accessing the data regarding the second pixel, the rendering device 110 may perform rasterization on the first pixel before performing rasterization on the second pixel.

As another example, when the order obtained in operation S520 corresponds to the N order, the rendering device 110 performs rasterization in the N order.

The rendering device 110 determines a rasterization order according to an order of accessing texture data stored in a memory in order to obtain pixel values or fragment values. For example, the rendering device 110 obtains an order regarding a memory access used to access the DRAM during the rendering and performs the rasterization according to the obtained order. The fragment shading order includes an order of accessing the data stored in the memory in order to perform the fragment shading.

As another example, the rendering device 110 obtains an orientation of a texture corresponding to the primitives on which the rendering is performed and determines the rasterization order based on the obtained orientation of the texture. The fragment shading order is a fragment shading order according to the orientation of the texture.

Also, as described above, in operation S540, the rasterization is performed according to the rasterization order determined in operation S530.

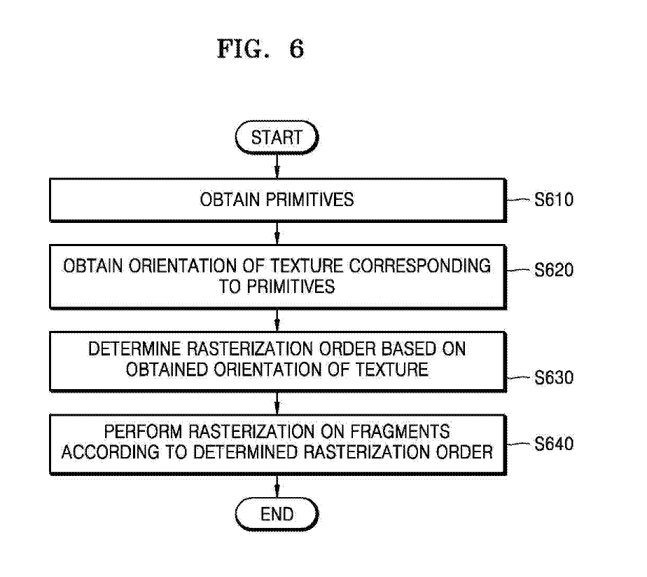

FIG. 6 is a flowchart of a method of performing, by the rendering device 110, rasterization based on an orientation of a texture, according to an embodiment.

Operations S610 and S640 respectively correspond to operations S410 and S440, and thus, details thereof will be omitted for convenience.

In operation S620, the rendering device 110 obtains an orientation of a texture corresponding to primitives. The orientation of the texture may be one of various orientations that are previously set. For example, the orientation of the texture may be a horizontal or vertical direction. The orientation of the texture may be a direction in which a texture corresponds to a direction of primitives.

In operation S630, the rendering device 110 determines the rasterization order based on the orientation of the texture obtained in operation S610.

The fragment shading order is determined based on the orientation of the texture. For example, a case where the DRAM in which data is stored in an order of first data and second data will be described. When a direction of the texture is a first direction, a left fragment may be processed based on the first data, and a right fragment may be processed based on the second data. When the direction of the texture is a second direction, a left fragment may be processed based on the second data, and a right fragment may be processed based on the first data. In this case, the fragment shading order is in a rightward direction when the direction of the texture is the first direction, and the fragment shading order is in a leftward direction when the direction of the texture is the second direction. The rendering device 110 determines the rasterization order according to the fragment shading order determined based on the orientation of the texture.

The rendering device 110 may obtain the orientation of the texture by determining whether the texture corresponding to the primitives has a horizontal or vertical orientation and may determine the rasterization order based on the obtained orientation of the texture. For example, the rendering device 110 determines whether the texture has a horizontal or vertical orientation, and when the texture has the horizontal orientation, the rasterization order is determined as the Z order. When the texture has the vertical orientation, the rasterization order is determined as the N order. As another example, when the texture has the horizontal orientation, the rasterization order may be determined to be in a rightward direction, and when the texture has the vertical orientation, the rasterization order may be determined to be in a downward direction.

The rendering device 110 obtains the orientation of the texture by using coordinate values of vertices forming the primitives. For example, the rendering device 110 obtains the orientation by using a difference between coordinates of a leftmost vertex of the primitives and coordinates of a rightmost vertex of the primitives. For example, the rendering device 110 selects a leftmost vertex and a rightmost vertex, obtains an x-axis coordinate difference ΔU and a y-axis coordinate difference ΔV between vertices, and compares a size of the x-axis coordinate difference ΔU with a size of the y-axis coordinate difference ΔV. When the x-axis coordinate difference ΔU is greater than the y-axis coordinate difference ΔV, the rendering device 110 may obtain the horizontal orientation, and when the y-axis coordinate difference ΔV is greater than the x-axis coordinate difference ΔU, the rendering device 110 may obtain the horizontal orientation.

The rendering device 110 determines the rasterization order in order to correspond to the obtained fragment shading order. Also, as described above, the fragment shading order is determined based on the orientation of the texture.

For example, when the fragment shading order obtained by the rendering device 110 is a rightward direction of the primitives, the rendering device 110 determines the rasterization order in the rightward direction.

As another example, when a direction corresponding to the fragment shading order obtained by the rendering device 110 is in a Z order, the Z order is determined as the rasterization order. As another example, when the direction corresponding to the fragment shading order obtained by the rendering device 110 is an N order, the N order is determined as the rasterization order. As another example, when the direction corresponding to the fragment shading order obtained by the rendering device 110 is a U order, the U is determined as the rasterization order.

Thus, as described above, rendering device 110 determines one of the predetermined rasterization orders in order to correspond to the obtained fragment shading order. The rendering device 110 may determine the rasterization order corresponding to the orientation of the texture from among at least one selected from the rightward-direction order, the downward-direction order, the Z order, the N order, and the U order. For example, when an order corresponding to the orientation of the texture is the Z order from among the rightward-direction order, the downward-direction order, the Z order, the N order, and the U order, the rendering device 110 determines the Z order as the rasterization order.

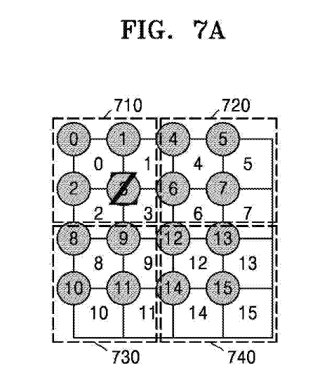

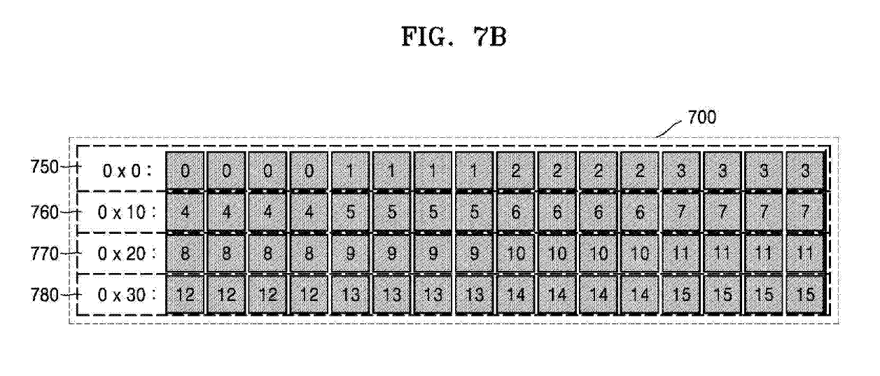

FIG. 7A is a diagram of an order of performing, by the rendering device 110, rasterization, according to an embodiment. More specifically, FIG. 7A illustrates a case in which a rasterization order obtained by the rendering device 110 is a Z order. In FIG. 7A, numbers in a circle indicate pixel IDs (identifications), and numbers in a square indicate a generation order.

When the rasterization order obtained by the rendering device 110 is the Z order, the rendering device 110 performs rasterization in the Z order. For example, the rendering device 110 performs the rasterization from a first block 710 to a second block 720, then to a third block 730, and then to a fourth block 740. Also, the rasterization is performed in the Z order in each of the first block 710, the second block 720, the third block 730, and the fourth block 740. For example, the rasterization is performed in the first block 710 from a zero pixel to a first pixel, then to a second pixel, and then to a third. In this case, an order in which pixels are generated corresponds to IDs of the pixels.

FIG. 7B is a diagram of a memory 700 accessed the rendering device 110 to perform rendering by, according to an embodiment. The memory 700 may be DRAM. Alternatively, the memory 700 may be cache memory. The memory 700 includes, for example, a first memory 750, a second memory 760, a third memory 770, and a fourth memory 780.

Numbers written in the memory 700 are be pixel IDs or fragment IDs corresponding to pieces of data stored in their corresponding memories, that is, the first memory 750, the second memory 760, the third memory 770, and the fourth memory 780. For example, data stored in the first memory 750 is used to perform rendering of a zero pixel to a third pixel.

Referring to FIG. 7B, it may be efficient to perform rendering on pixels in an order of pixel IDs. If rendering needs to be performed on a sixteenth pixel prior to the zero pixel, a data storage space is secured first by removing data stored in the first memory 750, and then data regarding the sixteenth pixel is received to thereby store the same in the memory 700. Also, in this case, when the rendering is performed again on the zero pixel, data regarding the zero pixel is received by the memory 700 and stored in the memory 700. Therefore, when the zero pixel is processed prior to the sixteenth pixel, unnecessary operations are omitted.

Pixel data is stored in the memory 700 in an order from a pixel ID of 0 to a pixel ID of 15. Therefore, referring to FIG. 7A, when the rasterization is performed in the Z order, the rasterization may be performed in an order from the zero pixel to a fifteenth pixel. Therefore, the rendering device 110 determines a rasterization order that is an order of accessing data stored in a memory as the Z order and may efficiently perform the rasterization by performing the rasterization in the determined Z order. In this case, the memory 700 may be accessed in an order from the first memory 750, the second memory 760, the third memory 770, and to the fourth memory 780.

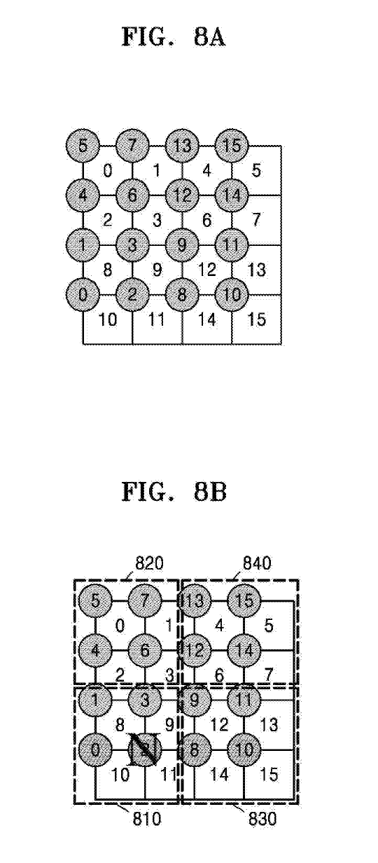

FIG. 8A is a diagram of a method of performing, by the rendering device 110, rasterization when an orientation of a texture is changed, according to an embodiment. For example, as shown in FIG. 8A, the orientation of the texture rotates by 90 degrees. In this case, a pixel ID is changed by 90 degrees in comparison with a case of FIG. 7A. A conventional block corresponding to the first block 710 of FIG. 7A becomes a first block 810 of FIG. 8A, and a conventional block corresponding to the second block 720 of FIG. 7A becomes a second block 820 of FIG. 8A. A conventional block corresponding to the third block 730 of FIG. 7A becomes a third block 830 of FIG. 8A, and a conventional block corresponding to the fourth block 740 of FIG. 7A becomes a fourth block 840 of FIG. 8A.

Locations of pixels within blocks are changed. The locations of the pixels within the blocks rotate by 90 degrees and may be located in respective blocks.

However, although the orientation of the texture is changed, an order of the data stored in the memory is the same.

FIG. 8B is a diagram of a method of performing, by the rendering device 110, rasterization in an N order when an orientation of a texture is changed, according to an embodiment. In this case, when the rasterization is performed in the Z order as shown in FIG. 7A, the memory 700 is accessed from the second memory 760, then the fourth memory 780, then the first memory 750, and then the third memory 770. Therefore, when the orientation of the texture is the same as in FIG. 8A, if the rasterization is performed in the Z order, a process of unnecessarily deleting and copying data in cache memory may be required.

Therefore, the rendering device 110 determines a rasterization order according to the orientation of the texture or an order of accessing data stored in the memory. For example, when the orientation of the texture is determined as shown in FIG. 8A, the rendering device 110 performs the rasterization in an N order.

When a rasterization order that is obtained by the rendering device 110 is the N order, the rendering device 110 may perform the rasterization in the N order. For example, the rendering device 110 performs the rasterization from the first block 810 to the second block 820, then to the third block 830, and then to the fourth block 840. Also, the rasterization is performed in the N order in each of the first block 810, the second block 820, the third block 830, and the fourth block 840. For example, the rasterization is performed in the first block 810 from a zero pixel to a first pixel, then to a second pixel, and then to a third pixel. In this case, a generation order of pixels corresponds to pixel IDs.

Pixel data is stored in the memory 700 in an order from a pixel ID of 0 to a pixel ID of 15. Therefore, referring to FIG. 8A, when the rasterization is performed in the N order, the rasterization is performed in the order from the pixel ID of 0 to the pixel ID of 15. Therefore, the rendering device 110 determines the rasterization order corresponding to the order of accessing the data stored in the memory as the N order and efficiently performs the rasterization by performing the rasterization in the determined N order.

When the rendering device 110 performs the rasterization in an order from the first block 810 to the second block 820, then to the third block 830, and then to the fourth block 840, the memory 700 is accessed in the order from the first memory 750 to the second memory 760, then to the third memory 770, and then to the fourth memory 780. In this case, DRAM may be continuously accessed because the memory 700 is accessed in the order from the first memory 750 to the second memory 760, then to the third memory 770, and then to the fourth memory 780, and thus a cache hit ratio may be improved.

FIG. 9 is a diagram of a method of determining, by the rendering device 110, an orientation of a texture, according to an embodiment. The rendering device 110 may determine an access orientation of the texture by analyzing a texture access pattern. For example, the rendering device 110 according to an embodiment may analyze a texture coordinate varying value of a certain number of fragments that are obtained at first and may determine whether a main orientation is an x axis or a y axis orientation.

As shown in FIG. 9, the rendering device 110 according to another embodiment obtains the orientation of the texture by using coordinate values of vertices forming primitives. The primitives, for example, include a first vertex 910, a second vertex 920, and a third vertex 930.

For example, the rendering device 110 obtains the orientation of the texture based on a difference between a coordinate value of a vertex located at a leftmost portion of the primitives and a coordinate value of a vertex located at a rightmost portion of the primitives. For example, the rendering device 110 obtains an x-axis coordinate difference ΔU and a y-axis coordinate difference ΔV between vertices that are selected by selecting the first vertex 910, which is located at a leftmost portion of the primitives, and the second vertex 920, which is located at a rightmost portion of the primitives, compares sizes of ΔU and ΔV, and determines a horizontal orientation when ΔU is greater than ΔV and determine a vertical orientation when ΔV is greater than ΔU.

A method of determining an orientation may be presented by pseudo codes as follows.

P_{left} = {P | whose x-coordinate is min(P0x, P1x, P2x) }
P_{right} = {P | whose x-coordinate is max(P0x, P1x, P2x) }
If( P_{left}.U − P_{right}.U > P_{right}.V − P_{left}.V)

x-major

else if( P_{left}.U − P_{right}.U > P_{right}.V − P_{left}.V)

y-major

As another example, the rendering device 110 determines an orientation of a texture by comparing a y-axis coordinate difference between an uppermost vertex and a lowermost vertex of the primitives and an x-axis coordinate difference between a leftmost vertex and a rightmost vertex of the primitives. For example, the rendering device 110 obtains an x-axis coordinate difference ΔU between the first vertex 910 that is a leftmost vertex and the second vertex 920 that is a rightmost vertex and a y-axis coordinate difference ΔV between the third vertex 930 that is an uppermost vertex and the second vertex 920 that is a lowermost vertex. Then, by comparing the x-axis coordinate difference ΔU and the y-axis coordinate difference ΔV, when the x-axis coordinate difference ΔU is greater than the y-axis coordinate difference ΔV, the orientation is determined to be a horizontal orientation, and when the y-axis coordinate difference ΔV is greater than the x-axis coordinate difference ΔU, the orientation is determined to be a vertical orientation.

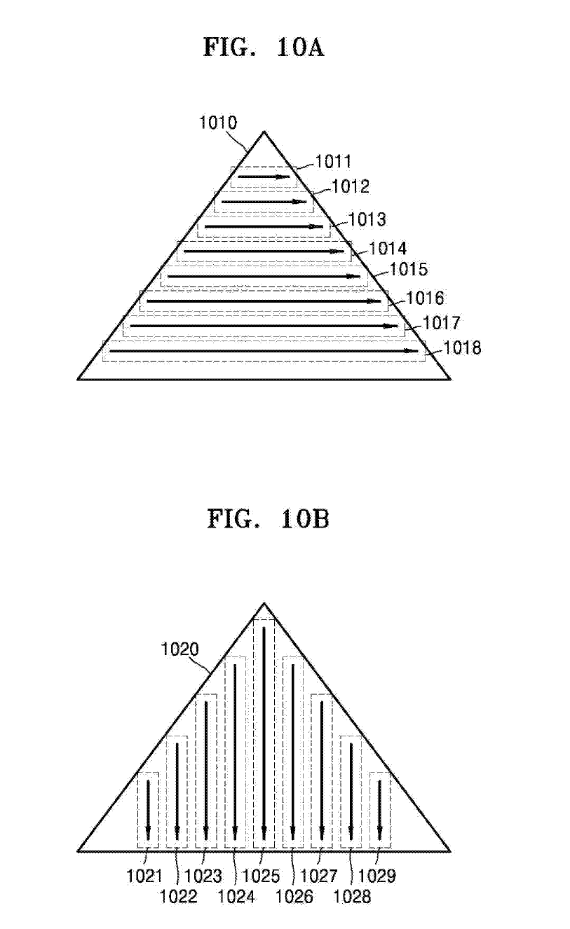

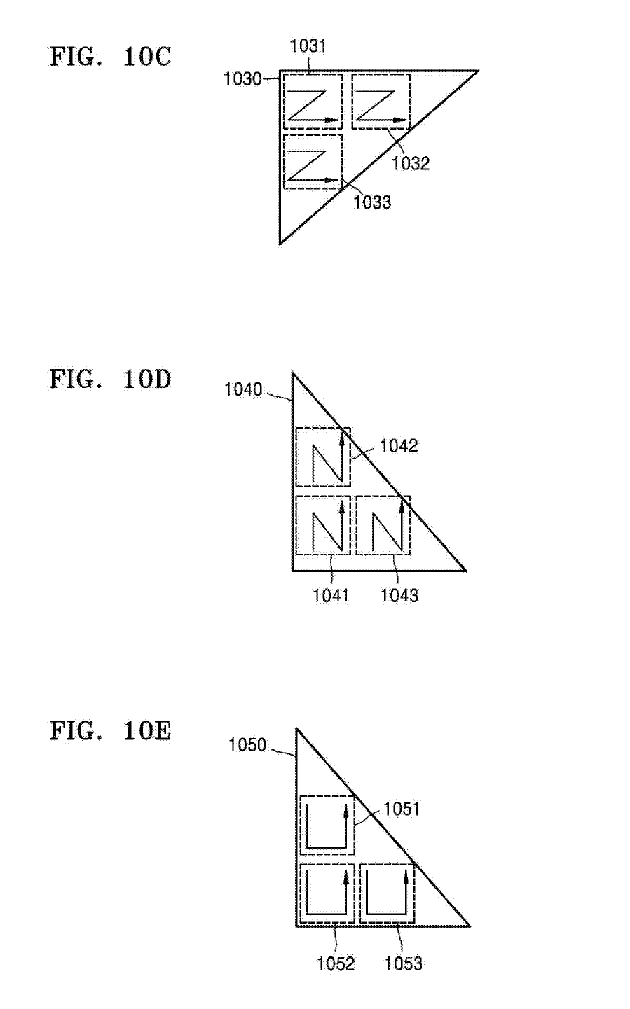

FIG. 10A is a diagram of a method of performing, by the rendering device 110, rasterization in a rightward direction, according to an embodiment. The rendering device 110 performs the rasterization on fragments according to a rasterization order determined with regard to a first primitive 1010.

For example, when the rasterization order is in a rightward direction, the rendering device 110 performs the rasterization in the rightward direction. For example, the rendering device 110 divides a primitive into one or more fragments in the rightward direction. As another example, the rendering device 110 generates fragments within a vertex by interpolating screen coordinates, texture coordinates, etc., defined at vertices of the primitive in the rightward direction. As another example, the rendering device 110 obtains pixels or fragments included in the primitive in the rightward direction.

In this case, the rendering device 110 performs the rasterization from first rasterization 1011 to the second rasterization 1012, then to the third rasterization 1013, then to the fourth rasterization 1014, then to the fifth rasterization 1015, then to the sixth rasterization 1016, then to the seventh rasterization 1017, and then to the eighth rasterization 1018.

FIG. 10B is a diagram of a method of performing, by the rendering device 110, rasterization in a downward direction, according to an embodiment. The rendering device 110 performs the rasterization on fragments according to a rasterization order determined with regard to a second primitive 1020.

For example, when the rasterization order is in a downward direction, the rendering device 110 performs the rasterization in the downward direction. For example, the rendering device 110 divides a primitive into one or more fragments in the downward direction. As another example, the rendering device 110 generates fragments within a vertex by interpolating screen coordinates, texture coordinates, etc., defined at vertices of the primitive in the downward direction. As another example, the rendering device 110 obtains pixels or fragments included in the primitive in the downward direction.

In this case, the rendering device 110 performs the rasterization from first rasterization 1021 to the second rasterization 1022, then to the third rasterization 1023, then to the fourth rasterization 1024, then to the fifth rasterization 1025, then to the sixth rasterization 1026, then to the seventh rasterization 1027, then to the eighth rasterization 1028, and then to the ninth rasterization 1029.

FIG. 100 is a diagram of a method of performing, by the rendering device 110, rasterization in a Z order, according to an embodiment. The rendering device 110 performs the rasterization on fragments according to a rasterization order determined with regard to a third primitive 1030.

For example, when the rasterization order is a Z order, the rendering device 110 performs the rasterization in the Z order. For example, the rendering device 110 divides a primitive into one or more fragments in the Z order. As another example, the rendering device 110 generates fragments within a vertex by interpolating screen coordinates, texture coordinates, etc., defined at vertices of the primitive in the Z order. As another example, the rendering device 110 obtains pixels or fragments included in the primitive in the Z order.

In this case, the rendering device 110 performs the rasterization from the first rasterization 1031 to the second rasterization 1032, and then to the third rasterization 1033.

FIG. 10D is a diagram of a method of performing, by the rendering device 110, rasterization in an N order, according to an embodiment. The rendering device 110 performs the rasterization on fragments according to a rasterization order determined with regard to a fourth primitive 1040.

For example, when the rasterization order is an N order, the rendering device 110 performs the rasterization in the N order. For example, the rendering device 110 divides a primitive into one or more fragments in the N order. As another example, the rendering device 110 generates fragments within a vertex by interpolating screen coordinates, texture coordinates, etc., defined at vertices of the primitive in the N order. As another example, the rendering device 110 obtains pixels or fragments included in the primitive in the N order.

In this case, the rendering device 110 performs the rasterization from first rasterization 1041 to the second rasterization 1042, and then to the third rasterization 1043.

FIG. 10E is a diagram of a method of performing, by the rendering device 110, rasterization in a U order, according to an embodiment. The rendering device 110 performs the rasterization on fragments according to a rasterization order determined with regard to a fifth primitive 1050.

For example, when the rasterization order is a U order, the rendering device 110 performs the rasterization in the U order. For example, the rendering device 110 divides a primitive into one or more fragments in the U order. As another example, the rendering device 110 generates fragments within a vertex by interpolating screen coordinates, texture coordinates, etc., defined at vertices of the primitive in the U order. As another example, the rendering device 110 obtains pixels or fragments included in the primitive in the U order.

In this case, the rendering device 110 performs the rasterization from first rasterization 1051 to the second rasterization 1052, and then to third rasterization 1053.

The apparatuses, units, modules, devices, and other components (e.g., the rendering device 110, shader core 120, texture processor 130, pixel processor 140, tile buffer 150, memory 200, order determiner 310 and rasterizer 320) illustrated in FIGS. 1 and 3 that perform the operations described herein with respect to FIGS. 2, 4-6 and 8A-10E are implemented by hardware components. Examples of hardware components include controllers, sensors, generators, drivers, and any other electronic components known to one of ordinary skill in the art. In one example, the hardware components are implemented by one or more processors or computers. A processor or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processor or computer includes, or is connected to, one or more memories storing instructions or software that are executed by the processor or computer. Hardware components implemented by a processor or computer execute instructions or software, such as an operating system (OS) and one or more software applications that run on the OS, to perform the operations described herein with respect to FIGS. 2, 4-6 and 8A-10E. The hardware components also access, manipulate, process, create, and store data in response to execution of the instructions or software. For simplicity, the singular term “processor” or “computer” may be used in the description of the examples described herein, but in other examples multiple processors or computers are used, or a processor or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 2, 4-6 and 8A-10E that perform the operations described herein with respect to FIGS. 1 and 3 are performed by a processor or a computer as described above executing instructions or software to perform the operations described herein.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processor or computer.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A rendering method comprising:
obtaining primitives;
obtaining a fragment shading order that is an order of shading fragments included in the obtained primitives;
determining a rasterization order corresponding to the obtained fragment shading order; and
performing rasterization on the fragments according to the determined rasterization order.

2. The rendering method of claim 1, wherein the fragment shading order comprises an order of accessing data stored in a memory in order to perform fragment shading.

3. The rendering method of claim 1, wherein the determining of the rasterization order comprises determining at least one rasterization order from among previously set rasterization orders.

4. The rendering method of claim 3, wherein the previously set rasterization orders comprise at least one of a Z order, an N order, and a U order.

5. The rendering method of claim 1, wherein the determining of the rasterization order comprises:
obtaining an orientation of a texture corresponding to the primitives; and
determining the rasterization order based on the obtained orientation of the texture.

6. The rendering method of claim 5, wherein the obtaining of the orientation of the texture corresponding to the primitives comprises obtaining the orientation of the texture by determining whether the texture corresponding to the primitives has a horizontal orientation or a vertical orientation.

7. The rendering method of claim 5, wherein the obtaining of the orientation of the texture corresponding to the primitives comprises obtaining the orientation of the texture by using a value of coordinates of vertices forming the primitives.

8. The rendering method of claim 5, wherein the obtaining of the orientation of the texture corresponding to the primitives comprises obtaining the orientation of the texture by using a difference between a value of coordinates of a leftmost vertex of the primitives and a value of coordinates of a rightmost vertex of the primitives.

9. The rendering method of claim 1, wherein the determining of the rasterization order corresponding to the obtained fragment shading order comprises determining the rasterization order according to an order of accessing texture data stored in a memory to obtain values of pixels or values of fragments.

10. A non-transitory computer-readable recording medium comprising stored instructions that are executable to cause a computer to perform the method of claim 1.

11. A rendering device comprising:
a processor including
an order determiner configured to obtain primitives and a fragment shading order that is an order of shading fragments included in the obtained primitives, and to determine a rasterization order corresponding to the obtained fragment shading order, and
a rasterizer configured to perform rasterization on the fragments according to the determined rasterization order.

12. The rendering device of claim 11, wherein the fragment shading order comprises an order of accessing data stored in a memory in order to perform fragment shading.

13. The rendering device of claim 11, wherein the order determiner is further configured to determine at least one rasterization order from among previously set rasterization orders.

14. The rendering device of claim 13, wherein the previously set rasterization orders comprise at least one of a Z order, an N order, and a U order.

15. The rendering device of claim 11, wherein the order determiner is further configured to:
obtain an orientation of a texture corresponding to the primitives; and
determine the rasterization order based on the obtained orientation of the texture.

16. The rendering device of claim 15, wherein the order determiner is further configured to obtain the orientation of the texture corresponding to the primitives by determining whether the texture has a horizontal orientation or a vertical orientation.

17. The rendering device of claim 15, wherein the order determiner is further configured to obtain the orientation of the texture corresponding to the primitives by using values of coordinates of vertices forming the primitives.

18. The rendering device of claim 15, wherein the order determiner is further configured to obtain the orientation of the texture corresponding to the primitives by using a difference between a value of coordinates of a leftmost vertex of the primitives and a value of coordinates of a rightmost vertex of the primitives.

19. The rendering device of claim 11, wherein the order determiner is further configured to determine the rasterization order according to an order of accessing texture data stored in a memory to obtain values of pixels and values of fragments.
